(19) United States
(12) Patent Application Publication
(10) Pub. No.: US 2007/0166678 A1
(43) Pub. Date: Jul. 19, 2007

(54) Method and articles for providing education related to religious text

(76) Inventor: Eugene Browning, Country Club Hills, IL (US)

Correspondence Address: Eugene Browning, 4187 West 186th Street, Country Club Hills, IL, 60478, US

(21) Appl. No.: 11/333,462

(22) Filed: Jan. 17, 2006

(51) Int. Cl. G09B 19/00

(52) U.S. Cl. 434/245

(57) ABSTRACT

A doll is uniquely designed, so that a collection of dolls may be acquired, which recite excerpts from religious text. The collection provides playmates for young children and serves as an educational tool for teaching verses of the teachings of Jesus Christ. Each doll wears a unique brand of clothing, and may have an accessory attached to it, such as an informative storybook that describes the doll's background, history, and environment as related to the excerpt of religious text recited by the doll. A method and articles are described which provide a child with an interactive mixture of information content and physical objects, all of which are directed to instilling in the child an appreciation for Christianity generally.

### BACKGROUND OF THE INVENTION

1. Field of the Invention

The invention herein relates to articles, specifically a child's doll, and methods for education and promotion related to using a doll for teaching excerpts from religious texts. More particularly it relates to methods for involvement of individuals, especially children, in appreciation of the teachings of Jesus Christ, and a doll with features attractive to children and which has a means for playing predetermined audio recordings of Biblical verses. This invention uses a doll that depicts a human with youthful features, or generally having features attractive to children.

2. Description of the Related Art

The major religions of the world are well known and studied. In the classrooms of religious schools and churches, there is an ongoing need to teach in a way that is attractive to young children. As religious teachings are traditional and constant, the parents and teachers are challenged to continue to find a means to teach a particular religious principle in a way that maintains the interest of their children. There is especially a need to teach children original, unedited verses from their religious text. Usually, children are taught interpretations of religious text by adults, rather than the actual verse. There has always been a desire to teach verse to children, but it is generally thought that a child cannot understand actual verse, and more easily understand interpretations of the verse through stories.

Children, however, are known to be attracted to dolls and toy animals. Dolls and toy animals are typically used in most children's media productions and toys. Therefore, to insure their future support in adulthood, what is needed is a playful and educational medium and method reachable by children, so that the children gain interest to explore the excerpts from religious text, thereby developing knowledge of their religion.

Successful educational programs are designed to provide a child with a series of enjoyable activities through which the child absorbs the educational information presented. Typically, the program is in the form of a toy linked to the educational information. Children learning in this manner retain and understand the information imparted for a significantly longer period than information that is presented to them in what they considered to be a dull or boring manner, such as the traditionally strict classroom environment. Further, older children absorb and understand information about significant issues when the information is presented in the context of enjoyable activities and imaginative toys.

It would therefore be advantageous if there were multimedia and interactive means for presenting information about religious text to youngsters in a manner that they would find enjoyable and which would allow them to relate to the welfare of humans and animals at an interest level appropriate to the age of the child, such that it would be likely that the interest would be maintained and grow throughout the individual's life.

Toy doll designers are constantly challenged to design toys that appeal to children and adults. Various methods are used to make toy dolls attractive or unique for children. For example, a doll may be designed to resemble an animal. Another method is to design a doll resembling a child of same age as the user. Another method is to design a doll that has play functions, such as a voice or an animal sound. There exists a need for a doll with features attractive to a child, and has a means for playing pre-recorded and predetermined recitations of religious text.

### BRIEF SUMMARY OF THE INVENTION

The present invention provides a child with an interactive mixture of information content, physical objects such as dolls and wearing accessories for the doll, and interconnection and communication with other like-minded children and supportive adults, all of which are directed to instilling in the child an appreciation for religious text. A unique feature of the present invention is that it causes the child to focus on a specific excerpt from a religious text described in an audio data source such as a taped or digital recording, and learn about the excerpt by playing with an imaginative doll that houses an audio device. The doll has accompanying accessories such as a necklace and clothing, formed in sizes for the doll to wear. This invention therefore allows the development of a bond between the child and the toy, as the child learns to recite text. The present invention provides an interactive method using physical objects, through which the child learns about religious principles and forms an attachment with the specific doll.

Therefore, in a principal embodiment, the invention involves a method for promotion of and education regarding excerpts from religious text, and which comprises providing an attractive doll; identifying a form for the doll; compiling a database comprising a first body of information regarding excerpts from religious text and a second body of information regarding explanation of the principle of the excerpt; requiring a first monetary payment by a person for access to at least a portion of said database and for purchase of said doll, said database, and said doll; and apportioning a part of said first monetary payment to maintenance of religious education to children.

In another embodiment, the invention involves an educational and play article having a configuration that is a recognizable effigy of the animal selected and identified in the method described above.

The invention is a beautiful doll that recites verses from the teachings of Jesus Christ and that has unique accompanying accessories. The invention provides a playmate for young children, but is also a collectable. Each doll has accessories reflecting popular children's clothing. Several dolls with unique features and accompanying accessories can be collected as a learning and playing set.

Numerous other embodiments and objects will be evident from the description below.

### BRIEF DESCRIPTION OF THE SEVERAL VIEWS OF THE DRAWINGS

FIG. 1 is a graphical representation of the various components of the present invention and of their interrelation.

### DETAILED DESCRIPTION OF THE INVENTION

The method of the present invention is best understood by reference to the FIGURES of the drawings. The invention is a method for promoting education of religious verses by children. The method works well for any religion, but is preferably practiced in the Christian religion for the teachings of Jesus Christ. The invention is especially useful for teaching children to memorize religious verses.

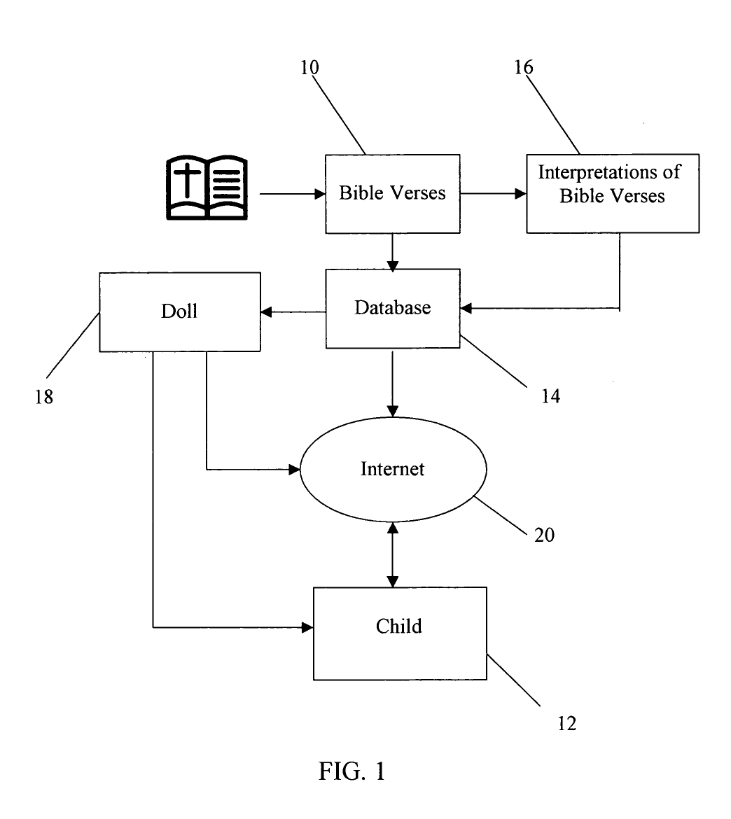

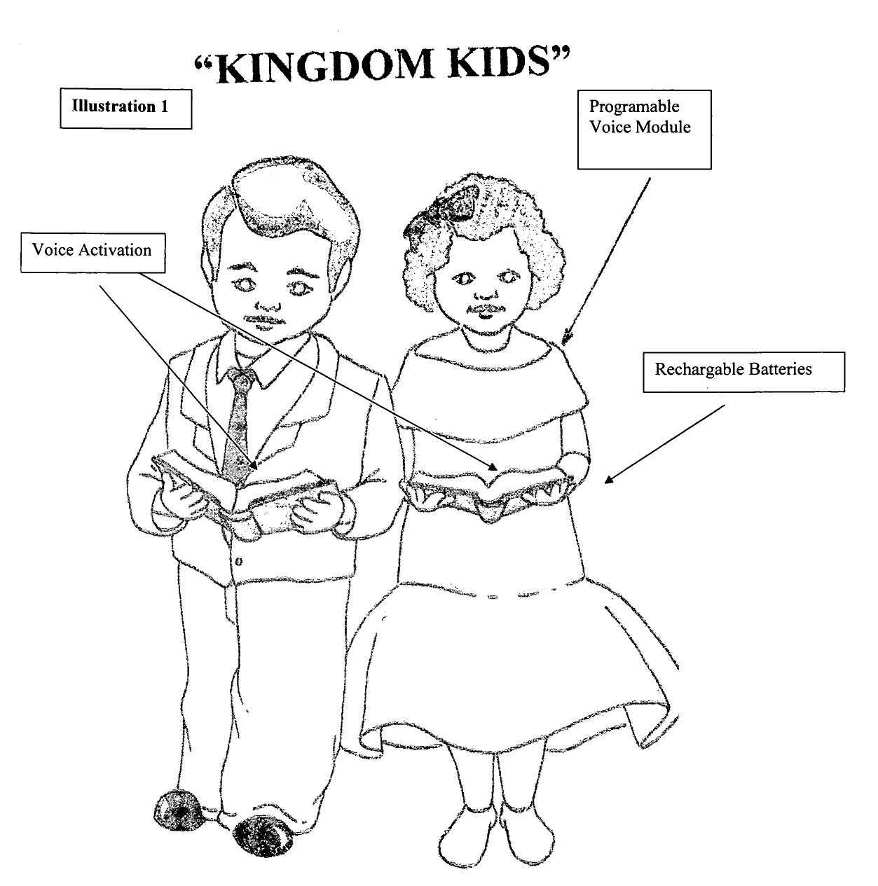

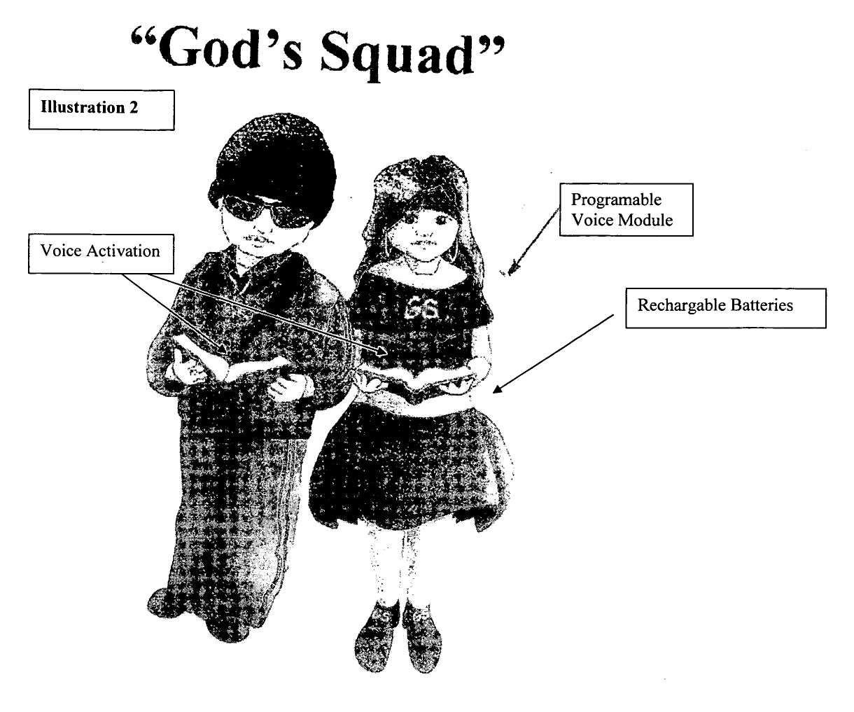

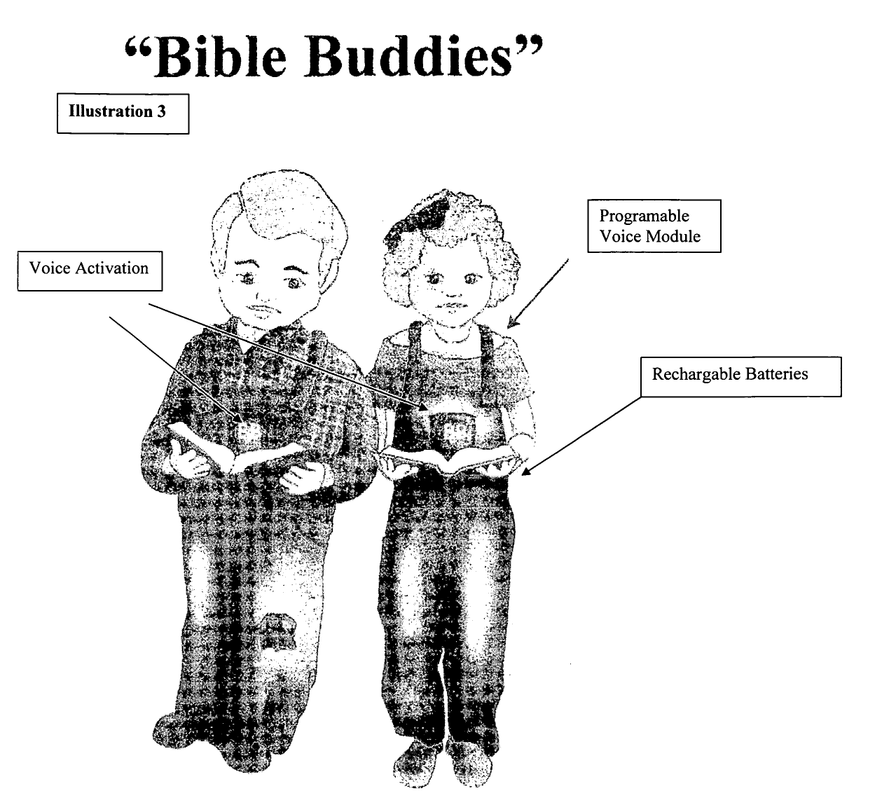

Looking at FIG. 1, the first step of the present inventive method is to identify a Biblical verse 10. Generally the verse 10 is a well-known verse or otherwise a verse which teaches a simple lesson to a younger minor or a child 12. However, any verse desired can be used. Recording the verse 10 on electronic media and an audio recording medium creates a database 14.

Next, the verses 10 are interpreted 16. An amount of information regarding excerpts from religious text, interpretation of the verse 10 into terms relevant to the target audience, such as children's stories or popular slogans, and other information which is of interest to children (and perhaps also to their parents) is collected and incorporated into the database 14. The verse 10 may be interpreted in the form of a fable story or simple translation into lay terms for the child's understanding. The interpretation 16 is captured and recorded on electronic media and the audio recording device, thereby including the interpretation in the database 14.

This content of the database 14 will be carefully edited and organized to provide high attraction to children. The verses 10 and interpretations 16 presented are carefully checked to insure accuracy and ease of comprehension.

The audio recording medium is embodied in a voice simulator device contained within a portion of a doll 18. The doll 18 has a switch for turning the voice simulator on and off. Preferably, the doll 18 has a configuration that is a recognizable effigy of a child or an adolescent. The doll 18 is equipped with a port for accepting the recording medium and audibly transmitting the content thereof The port has mechanical features the child 12 can utilize, enabling a child to work the doll 18 to hear the content on the recording medium.

It is a fundamental in the Christian religion to provide access to the teachings of Jesus Christ freely, and to encourage others to listen to those teachings. Therefore, an imperative step in this inventive method is providing access to the doll 18. Providing a person an opportunity to purchase the doll 18 provides access to the verse 10. Part of the money is used for furthering the cause of teaching Biblical verses to children and adolescents, and to support religious education of minors generally.

The operator may work in conjunction with one or more general religious organizations, and churches, which work for children's education of original Biblical verse and religious text. This interaction will include funding for the organization from the operator, which can be reciprocated by the religious organization, which provides the operator with an audience of prospective purchasers. The method of this invention enhances children's education, knowledge and interest regarding the teachings of Jesus Christ in their original and unedited verse 10.

It will be recognized that the method of this invention thus is a significant educational tool for teaching children the unedited religious verse 10. It has long been recognized that children learn best and retain longer what they learn, if the learning activity is fun to them. The integrated aspects of the doll 18 in the present method thus attract the interest of the child 12 and provide an enjoyable activity in which learning occurs while playing. The method of the present invention thus represents a unique combination of learning which is mutually beneficial to both the child 12 and educators.

It is contemplated that the method relies on the attractiveness of the doll 18. Therefore, the doll 18 will be provided wearing a uniquely designed clothing line. The clothing will mimic popular culture clothing lines for children, as well as traditional clothing for children. A multiplicity of the dolls may be collected, as well as various clothing and costumes for each doll 18. The doll 18 has portions for carrying accessories, such as a backpack that can be strapped on the shoulders of the doll 18.

It is further contemplated that the inventive method involves encouraging the purchaser and otherwise the user of the doll 18 to visit an internet site 20 to purchase the doll 18 and various other accessories and merchandise. Part of the first monetary payment will be used in the maintenance of teaching religious verses to children and adolescents, and to support religious education to minors generally. Furthermore, the internet site 20 permits a visitor, including the child 12, to learn and enjoy the teachings of Jesus Christ without spending money.

In alternative embodiments, more than one Biblica! verse 10 may be utilized in the method. In this way, several lessons may be taught in one sitting. For example, prior to the child's 12 bedtime, a caregiver could teach several verses to the child 12 to compose an overall Biblical lesson.

It will be evident that there are numerous embodiments of the present invention which are not expressly described above, but which are clearly within the scope and spirit of the invention. The above description is to be considered exemplary only, and the scope of the invention is to be defined solely by the claims.

1. A method for promotion of and children's education regarding religion which comprises:
identifying a verse from a religious text;
compiling a database comprising a first body of information regarding said verse, said body of information regarding an interpretation of said verse, and compiling said database into a form selected from a group consisting of electronic media, audio recording and playback equipment, and a global network computer system;
providing a doll having a configuration which is a recognizable effigy of a child or an adolescent, having housed therein a voice simulator for communicating to an operator said first body of information and said second body of information;
providing access to said database and an opportunity to purchase said doll, and said database, to a person;
requiring a first monetary payment by said person for access to at least a portion of said database and for purchase of said doll, and said database, and said electronic media; and
apportioning a part of said first monetary payment to maintenance of teaching religious verses to children and adolescents, and to support religious education to minors generally.

2. A method as in claim 1 further comprising providing merchandise related to said doll, and said database, and providing means through a global computer network system for said person to purchase said merchandise for a second monetary payment, and apportioning a part of said first monetary payment to maintenance of teaching religious verses to children and adolescents, and to support religious education to minors generally.

3. A method as in claim 1 further comprising said access to said database comprising an interactive exchange between said person and said database through said electronic media or through a computer link to a global computer network system.

4. A method as in claim 1 wherein said religious text is the teachings of the Lord Jesus Christ.

5. A method as in claim 1 wherein said religion is the Christian religion.

6. A method as in claim 1 further comprising identification of a plurality of verses.

7. A method as in claim 1 wherein said person is a child.
